(19) United States
(12) Patent Application Publication
(10) Pub. No.: US 2011/0248560 A1
(43) Pub. Date: Oct. 13, 2011

(54) Method For Controlling A Hydraulic Vehicle Brake System

(75) Inventors: Herbert Vollert, Vaihingen/Enz (DE); Reinhard Weiberle, Vaihingen/Enz (DE); Frank Kneip, IIsfeld (DE)

(73) Assignee: Robert Bosch GmbH, Stuttgart (DE)

(21) Appl. No.: 13/140,539

(22) PCT Filed: Dec. 9, 2009
(86) PCT No.: PCT/EP2009/066695

§ 371 Date: Jun. 17, 2011

(30) Foreign Application Priority Data
Dec. 18, 2008 (DE) 10 2008 054 856.1

(51) Int. Cl. B60T 15/42; B60T 13/128; G06F 19/00

(52) U.S. Cl. 303/13; 701/70

(57) ABSTRACT

A method for controlling a hydraulic vehicle brake system having an electromechanical brake booster, includes activating the brake booster and a master brake cylinder of the vehicle brake system in response to a desire to brake, and reducing a clearance in the wheel brakes.

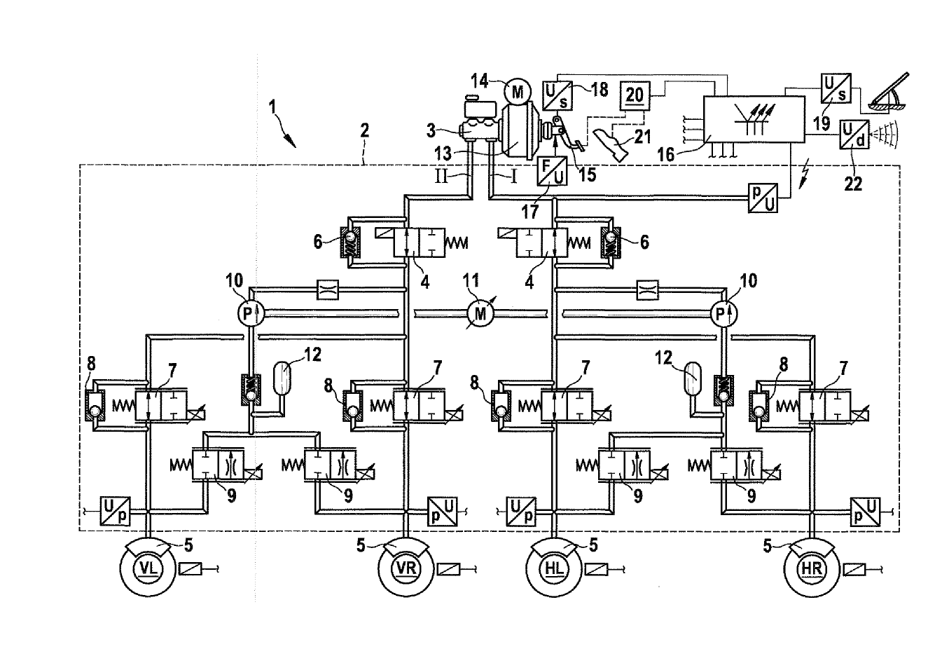

### PRIOR ART

The invention relates to a method for controlling a hydraulic vehicle brake system having a brake booster and having the features in the preamble of claim 1. “Control” in the sense of the invention is intended to include both open-loop and closed-loop control.

Hydraulic vehicle brake systems are known per se. They have a master brake cylinder, to which one or more wheel brake cylinders of wheel brakes are connected, also referred to here simply as “wheel brakes” for short. Actuation is accomplished by foot by means of a brake pedal or by hand using a brake lever. The master brake cylinder generally has a vacuum brake booster.

Hydraulic vehicle brake systems with wheel slip control, e.g. anti-lock (brake) control, drive slip control and/or vehicle dynamics control, are also known. The abbreviations ABS, ASR, FDR and ESP are customary in German for these control systems. For control, the vehicle brake systems have wheel brake pressure modulation valve arrangements and a hydraulic pump in each brake circuit, by means of which the wheel brake pressures of each individual wheel can be controlled/modulated, control/modulation also being exercised per axle in the case of some simpler systems. The hydraulic pump in a wheel slip control system is often referred to as a return pump. One possible and known practice in such vehicle brake systems is to pump brake fluid into the wheel brakes by means of the hydraulic pump before a brake actuation in order to reduce a release clearance in the wheel brakes, and preferably to place friction brake pads of the wheel brakes against a brake disk, a brake drum or some other brake element to be braked. The release clearance is a gap between the friction brake pads and the brake element when the brake is not actuated. The friction brake pads can be placed against the brake element without being subjected to any force or pressed against it with a slight clamping force. During a subsequent brake actuation, there is no need to overcome the release clearance, an idle travel during brake actuation is shortened and brake actuation takes place more quickly. Another advantage is that there is a larger actuation travel available for brake actuation.

The reduction in the release clearance takes place in response to a possible desire for braking on the part of a driver. Typically, rapid release of a gas pedal or of a gas throttle grip of a motor vehicle is regarded as such a desire for braking. In this case, “rapid” means more rapid, in particular considerably more rapid, release of the gas pedal or gas throttle grip than normal, it being possible for the normal speed of release of the gas pedal or gas throttle grip to be driver-specific, namely for it to be measured during driving. If the gas pedal or the gas throttle grip is released quickly, a subsequent brake actuation, often in fact a sharp brake actuation, can be expected. The reduction in the release clearance can also take place each time the gas pedal or gas throttle grip is released, irrespective of the speed of release. A possible desire for braking can also be determined by a clearance radar, which is known for maintaining a speed-dependent minimum clearance with respect to a vehicle in front. If the vehicle approaches a vehicle in front at a considerably higher speed or is moving toward an obstacle, the release clearance in the wheel brakes can be reduced by pumping brake fluid with the hydraulic pump in order to shorten the brake actuation time.

### DISCLOSURE OF THE INVENTION

The invention provides a controllable brake booster, where controllable refers to the capacity for open-loop or closed-loop control independently of actuation by muscle power, for actuating the brake booster. In particular, the brake booster is electrically or electronically controllable. According to the invention, the brake booster is actuated in response to a possible desire for braking, with the result that the release clearance in the wheel brakes of the vehicle brake system is reduced, in particular is reduced to “zero”. A certain preloading of the vehicle brake system, i.e. pressing of the friction brake pads of the wheel brakes against the brake disks, brake drums or other brake elements thereof with a slight clamping force, i.e. slight brake actuation, is also possible. The invention shortens the actuation travel during a brake actuation, in particular an idle travel is shortened, up to the point when the vehicle brake system “responds”, i.e. brakes. The idle travel can be shortened to “zero”; as already stated, the vehicle brake system can even be “preloaded”, i.e. a slight braking force can be built up.

It is a significant advantage of the invention that the return pump, i.e. the hydraulic pump of a wheel slip control system, is not used to reduce the release clearance of the wheel brakes in order to prepare a brake actuation. In terms of their service life, hydraulic pumps of wheel slip control systems are not designed for use in each brake actuation but only for infrequent brake actuations, because wheel slip control is a rare occurrence in day-to-day traffic. The reduction in the release clearance with the hydraulic pump of a wheel slip control system therefore necessitates that the vehicle brake system be equipped with hydraulic pumps which have a service life which is several times longer. Brake boosters, on the other hand, are used in each brake actuation and are therefore designed from the outset for an appropriate service life or number of actuations.

The subclaims relate to advantageous embodiments and developments of the invention.

As already explained, release or rapid release of a gas pedal or of a gas throttle grip of a motor vehicle equipped with the vehicle brake system can be regarded as a possible desire for braking. Another criterion of a possible desire for braking is the clearance with respect to a vehicle in front or with respect to an obstacle, in particular as a function of the driving speed, and the change in the clearance, i.e. the rate of approach to the vehicle in front or the obstacle can also form the criterion for the possible desire for braking. Claim 3 provides a sensor system which detects an approach of a driver's foot to a brake pedal. The approach of the driver's foot to the brake pedal is regarded as a possible desire for braking, triggering the actuation of the brake booster to reduce the release clearance of the wheel brakes. An optical sensor, one employing a light barrier for example, an ultrasound sensor, or a capacitive sensor are possible. This list is not exhaustive: any sensor system by means of which the approach of the driver's foot to the brake pedal can be detected may be considered for use in the invention.

Claim 4 envisages that the vehicle brake system have a valve, by means of which at least one wheel brake can be isolated hydraulically from a master brake cylinder of the vehicle brake system. Vehicle brake systems with wheel slip control have such valves, namely in general one isolating valve per brake circuit, by means of which the brake circuit is connected to the master brake cylinder, and one brake pressure buildup valve per wheel brake, or alternatively, in the case of simple wheel slip control systems, one brake pressure buildup valve for the wheel brakes on one vehicle axle. Claim 4 envisages that, in response to the possible desire for braking, the valve be closed and the brake booster be actuated as described, with the result that the release clearance of the wheel brakes is reduced. If the valve has a bypass, it can be closed before, during or after the actuation of the brake booster. Such a bypass, namely a check valve through which fluid can flow from the direction of the master brake cylinder in the direction of the wheel brakes, generally has the isolating valve. In the absence of a bypass, the valve can be closed only after the brake booster has been actuated and the release clearance of the wheel brakes has been reduced. The brake booster is then reset to its initial position. The advantage of this embodiment of the method according to the invention is that the brake booster is in its initial position at the beginning of a brake actuation, thus ensuring that the entire actuation travel of the brake booster is available.

If the valve has a bypass, it does not need to be opened during a brake actuation. However, claim 5 envisages opening the valve upon brake actuation, the valve preferably being opened only when the pressure in the master brake cylinder is approximately equal to or even greater than that in the wheel brakes.

The method according to the invention can also be used for setting a release clearance and/or setting a brake pedal travel. This is the subject matter of claim 6. The first option means that the release clearance of the wheel brakes is reduced independently of a possible desire for braking. The release clearance can be set for each wheel individually if there is a wheel slip control system present. A release clearance inherent in the design of the wheel brakes can thereby be reduced, and this reduction can also be wheel-specific.

In principle, the method according to the invention can be used with any controllable brake booster. For this purpose, a vacuum brake booster has a controllable valve, for example, for supplying air to a working chamber, in addition to an existing servo valve, which supplies air to the working chamber as a function of the travel of a piston rod and/or of a muscle force exerted thereon. Claim 7 provides an electromechanical brake booster, which is electrically or electronically controllable by virtue of the design thereof. Electromechanical brake boosters are known, reference being made by way of example to Laid-Open Application DE 100 57 557 A1.

### BRIEF DESCRIPTION OF THE DRAWING

The invention is explained below in greater detail with reference to the drawing. The single FIGURE shows a circuit diagram of a hydraulic vehicle brake system for the purpose of explaining the method according to the invention.

### EMBODIMENT OF THE INVENTION

The hydraulic vehicle brake system 1 according to the invention, which is illustrated in the drawing, has a wheel slip control system 2 (anti-lock control system ABS; drive slip control system ASR; vehicle dynamics control system FDR, ESP). It is designed as a dual circuit brake system with two brake circuits I, II, which are connected to a master brake cylinder 3. Each brake circuit I, II is connected to the master brake cylinder 3 via an isolating valve 4. In their de-energized home position, the isolating valves 4 are open 2/2-way solenoid valves. Connected hydraulically in parallel with each of the isolating valves 4 is a check valve 6, through which fluid can flow from the master brake cylinder 3 to wheel brakes 5. The wheel brakes 5 are connected to the isolating valve 4 of each brake circuit I, II via brake pressure buildup valves 7. In their de-energized home position, the brake pressure buildup valves 7 are open 2/2-way solenoid valves. Connected in parallel therewith are check valves 8, through which fluid can flow from the wheel brakes 5 in the direction of the master brake cylinder 3.

Connected to each wheel brake 5 is a brake pressure reduction valve 9, said reduction valves being connected jointly to a suction side of a hydraulic pump 10, which is also referred to as a return pump. The brake pressure reduction valves 9 are designed as 2/2-way solenoid valves that are closed in the de-energized home position thereof. A pressure side of the hydraulic pump 10 is connected between the brake pressure buildup valves 7 and the isolating valves 4, i.e. the pressure side of the hydraulic pump 10 is connected to the wheel brakes 5 via the brake pressure buildup valves 7 and to the master brake cylinder 3 via the isolating valve 4. The brake pressure buildup valves 7 and the brake pressure reduction valves 9 are proportional valves, since these provide better open-loop and closed-loop control.

Each of the two brake circuits I, II has a hydraulic pump 10, which can be driven jointly by means of an electric motor 11. The suction sides of the hydraulic pumps 10 are connected to the brake pressure reduction valves 9. On the suction side of the hydraulic pumps 10 there are hydraulic accumulators 12 for acceptance and temporary storage of brake fluid, which flows out of the wheel brakes 5 during slip control due to the opening of the brake pressure reduction valves 9.

The brake pressure buildup valves 7 and the brake pressure reduction valves 9 form wheel brake pressure modulation valve arrangements, by means of which wheel-specific brake pressure control for slip control is possible, in a manner which is known per se and will not be explained here, when the hydraulic pump 10 is being driven. During a slip control operation, the isolating valves 4 are closed, i.e. the vehicle brake system 1 is isolated hydraulically from the master brake cylinder 3.

The master brake cylinder 3 has a brake booster 13, in the illustrative embodiment an electromechanical brake booster 13, which, with the aid of an electric motor 14, produces an auxiliary force which, together with a muscle force applied via a brake pedal 15, actuates the master brake cylinder 3. The symbolically illustrated electric motor 14 is integrated into the brake booster 13. The electric motor 14 can be a rotary motor, the rotary motion of which is stepped down by means of a gear and converted into a translatory motion to actuate the master brake cylinder 3. Embodiment of the brake booster 13 with an electric linear motor or an electromagnet is also possible. This list is not exhaustive. Moreover, an electromechanical brake booster 13 is not essential to the invention: other brake boosters that can be controlled by means of an electronic control unit 16 are also possible.

The electronic control unit 16 already mentioned is present for open-loop or closed-loop control of the vehicle brake system 1, including the brake booster 13. A muscle or pedal force exerted on the brake pedal 15 can be measured by means of a force sensor 17, and a position and a speed or acceleration of the brake pedal 15 can be measured by means of a displacement sensor 18. The position of a gas pedal or the speed of actuation and, in particular, speed of release, thereof can be measured by means of a gas pedal sensor 19. Also provided is a foot sensor 20, by means of which a foot 21 of a driver or the movement thereof in the direction of the brake pedal 15 can be measured. The foot 21 is represented symbolically by a shoe. An optical sensor or a light barrier, an ultrasound sensor or a capacitive sensor, for example, are suitable for the foot sensor 20. This list is not exhaustive: any sensor or sensor system by means of which the approach of an object, in the present case the foot 21 of a driver, to the brake pedal 15 can be detected is possible. Moreover, there is a clearance sensor 22, by means of which the clearance of a vehicle fitted with the vehicle brake system 1 with respect to a vehicle in front or to an obstacle can be measured. Such clearance sensors 22 are used for speed-dependent clearance control. The foot sensor 20 and the clearance sensor 22 are provided for special embodiments or developments of the method according to the invention.

In the method according to the invention, the brake booster 13 is activated in response to a possible desire for braking by a driver while the vehicle brake system 1 is not (yet) actuated. That is to say, the brake booster 13 is actuated in the absence of brake actuation, but rather in the expectation of an imminent brake actuation, and, for its part, actuates the master brake cylinder 3. The master brake cylinder 3 is actuated in such a way that a release clearance in the wheel brakes 5 is reduced, the release clearance preferably being eliminated, i.e. friction brake pads of the wheel brakes 5 come to rest against brake disks, brake drums or other brake elements of the wheel brakes 5. The friction brake pads can be pressed against the brake element while being subjected to virtually no force or, alternatively, pressed against it with a slight clamping force, a slight clamping force involving a slight brake actuation. A return of a gas pedal into an idle position, for example, which is measured by means of the gas pedal sensor 19, is regarded as a possible desire for braking. Another possible criterion of a possible desire for braking is the speed of return of the gas pedal, especially an unusually rapid return of the gas pedal. The approach of the foot 21 of the driver to the brake pedal 15, which can be detected by means of the foot sensor 20, or the approach of the vehicle to a vehicle in front or to an obstacle, which is measured by means of the clearance sensor 22, can likewise be regarded as a possible desire for braking. This list of circumstances that can be regarded as a possible desire for braking is not exhaustive. By virtue of the reduction or, preferably, elimination of the release clearance of the wheel brakes 5 in response even to the possible desire for braking, a subsequent actual brake actuation takes place more quickly because there is no need for an idle travel of the brake pedal 15 to overcome the release clearance of the wheel brakes 5.

One embodiment of the method according to the invention envisages that not only the brake booster 13 but also either the isolating valves 4 or the brake pressure buildup valves 7 should be closed in response to the possible desire for braking. Because the isolating valves 4 have, in the check valves 6 connected in parallel therewith, a bypass through which fluid can flow in the direction of the wheel brakes 5, the isolating valves 4 can be closed before, at the same time as or even after actuation of the brake booster 13. The brake pressure buildup valves 7 are closed only after actuation of the brake booster 13, that is to say after reduction or elimination of the release clearance of the wheel brakes 5, because the check valves 8 connected in parallel therewith do not allow flow in the direction of the wheel brakes 5. The closure of the isolating valves 4 or of the brake pressure buildup valves 7 means that the volume of brake fluid displaced from the master brake cylinder 3 into the wheel brakes 5 by actuation of the brake booster 13 in response to the possible desire for braking is trapped in the wheel brakes 5 or vehicle brake system 1. The brake booster 13 is reset to its initial position. As a result of the volume of brake fluid trapped in the wheel brakes 5 or the vehicle brake system 1, the release clearance of the wheel brakes 5 remains reduced or eliminated. The isolating valves 4 or the brake pressure buildup valves 7 are reopened if a braking operation through actuation of the brake pedal 15 does in fact take place after actuation of the brake booster 13 in response to the possible desire for braking. The isolating valves 4 or the brake pressure buildup valves 7 can be opened immediately upon actuation of the brake pedal 15 or, alternatively, only when the pressure in the master brake cylinder 3 has approximately attained the pressure in the vehicle brake system 1 or in the wheel brakes 5. The isolating valves 4 or the brake pressure buildup valves 7 are reopened even if the possible desire for braking is no longer present, thus for example if a certain period of time has passed since the release of the gas pedal or the gas pedal is actuated again or if the foot 21 of the driver is removed from the brake pedal 15.

The method according to the invention can also be employed independently of a possible desire for braking for setting a release clearance or setting a brake pedal travel. For example, a release clearance of the wheel brakes 5 inherent in the design can be reduced through actuation of the brake booster 13. For this purpose, the movement of the brake pedal 15 during a brake actuation from the initial position of the brake pedal 15 up to a measurable increase in the hydraulic pressure in the vehicle brake system 1 can be measured by means of the displacement sensor 18, for example. The increase in pressure indicates the contact between the friction brake pads of the wheel brakes 5 and the brake elements of the latter. This travel can be shortened through actuation of the brake booster 13, i.e. adjustment of the initial position thereof, hence reducing the release clearance of the wheel brakes 5. Wheel-specific measurement of the idle travel up to contact between the friction brake pads of the wheel brakes 5 and the brake elements of the latter is also possible, preferably while the vehicle is stationary. In this case, wheel-specific setting of the release clearance is possible for each individual wheel through actuation of the brake booster 13, by closing all the brake pressure buildup valves 7 but one and likewise closing the brake pressure buildup valve 7 that has remained open after the setting of the release clearance. The method is carried out for each wheel brake 5 in succession.

1. A method for controlling a hydraulic vehicle brake system having a brake booster, comprising:
actuating the brake booster in response to a possible desire for braking, with the result that a release clearance in wheel brakes is at least reduced,
wherein the brake booster is controllable.

2. The method as claimed in claim 1, wherein one or more of release and rapid release of a gas pedal or of a gas throttle grip is regarded as a possible desire for braking.

3. The method as claimed in claim 1, wherein the approach of a foot of a driver to a brake pedal is detected by a sensor system and regarded as a possible desire for braking.

4. The method as claimed in claim 1, wherein:
the vehicle brake system has a valve, by means of which a wheel brake can be isolated hydraulically from a master brake cylinder of the vehicle brake system, and
in response to the possible desire for braking, the valve is closed and the brake booster is actuated, with the result that the release clearance in the wheel brakes is at least reduced, and that the brake booster is then reset.

5. The method as claimed in claim 4, characterized in that wherein the valve is opened upon brake actuation.

6. The method as claimed in claim 1, wherein the method is used for one or more of setting a release clearance and setting a brake pedal travel.

7. The method as claimed in claim 1, wherein the vehicle brake system has an electromechanical brake booster.
